(19) United States
(12) Patent Application Publication
(10) Pub. No.: US 2014/0279303 A1
(43) Pub. Date: Sep. 18, 2014

(54) IMAGE CAPTURE AND PROCESSING FOR FINANCIAL TRANSACTIONS

(71) Applicant: FISERV, INC., Brookfield, WI (US)

(72) Inventors: Sergio Andres van Dam, Wellington (NZ); Oliver I-Ju Chiang, Auckland (NZ)

(73) Assignee: FISERV, INC., Brookfield, WI (US)

(21) Appl. No.: 13/844,039

(22) Filed: Mar. 15, 2013

(51) Int. Cl. G06Q 40/00

(52) U.S. Cl. CPC G06Q 40/12
USPC 705/30

(57) ABSTRACT

Systems, methods and computer-readable media for image capture and processing for financial transactions are disclosed. An image of a document may be received on behalf of a user. One or more text fields associated with the image may be identified. The one or more candidate financial transactions may be identified based at least in part on the identified one or more text fields. The one or more candidate financial transactions may be transmitted for presentment to the user. A selection of a candidate financial transaction may be received on behalf of the user. The image may be associated with the selection of the candidate financial transaction.

### BACKGROUND

A variety of documents, both electronic and non-electronic, may be relevant to financial transactions in one or more transaction systems of record. These documents may exist in a number of places or systems completely unassociated with the corresponding financial transactions in the transaction systems.

### BRIEF DESCRIPTION OF THE DRAWINGS

The detailed description is set forth with reference to the accompanying drawings. Use of the same reference numerals indicates similar or identical components or elements; however, similar components or elements may also be designated with different reference numerals. Various embodiments of the disclosure may utilize elements or components other than those illustrated in the accompanying drawings and some elements and/or components may not be present in one or more embodiments. It should be appreciated that while singular terminology may be used to describe various components or elements, a plural number of such components or elements is also within the scope of the disclosure.

FIG. 1 schematically depicts an illustrative networked architecture for capturing and processing images for financial transactions in accordance with one or more embodiments of the disclosure.

FIG. 2 schematically depicts an illustrative image and transaction reconciliation computer in accordance with one or more embodiments of the disclosure.

FIG. 3 schematically depicts an illustrative data flow for image capture and processing for financial transactions.

FIGS. 4-6 are process flow diagrams depicting illustrative methods for image capture and processing for financial transactions in accordance with one or more embodiments of the disclosure.

FIGS. 7A-7C illustrate example user interfaces for viewing a transaction history on a mobile device in accordance with one or more embodiments of the disclosure.

### DETAILED DESCRIPTION

### Overview

Systems and methods in accordance with various embodiments of the present disclosure are directed to image capture and processing for financial transactions. A system for image capture and processing for financial transactions as described herein may provide functionality that may extract relevant data from a received document image and then, based on the extracted data, identify one or more financial transactions that may correspond to the image. The one or more financial transactions may be identified from one or more transaction systems of record.

In some embodiments, the systems and methods described herein may provide a variety of different functionality. For example, the system may determine a “best-fit” transaction based at least in part on a matching confidence level associated with each of the identified candidate financial transactions. Images may be automatically associated with the “best-fit” transaction. Transactions may be ordered according to their respective matching confidence levels. The candidate transactions may be identified and transmitted for presentation to a user. A user may select one or more of the presented candidate transaction to associate with an image. The system may receive a selection identifying one or more transactions and associate the image with the selected one or more transactions.

The image processed by the systems and methods described herein may have an associated document type. For example, an image captured and/or processed may be a purchase receipt, a purchase order, an invoice, a product description, a warranty, an insurance policy, or an insurance explanation of benefits.

In some embodiments, the image may be received from a client application system on behalf of a user, who may be using the client application system directly or only indirectly. The user may be a party to the financial transaction. The user may be a consumer or a merchant. The user interface (UI) application that captures the image may be a mobile device application, and the image may be captured by the mobile device camera. Alternatively, the UI application may be a “thin” (e.g., Web browser-based) client application or even a “thick” client application running on a personal computer, and the image may be captured using a scanner (e.g., attached to the computer or on the same local network). The client application system may encompass the UI application, or may be a server-based system.

The image may be stored in any of a variety of systems. Likewise, the association between the image and a transaction may be stored in any of a variety of systems. Such an association may be based on one or more identifiers (e.g., an identifier of the image, an identifier of the transaction), and may enable subsequent retrieval of the image when viewing the transaction, as well as potential subsequent use or processing of the image.

### Illustrative Architectures

FIG. 1 schematically depicts an illustrative networked architecture 100 for image capture and processing for financial transactions in accordance with one or more embodiments of the disclosure. FIG. 2 schematically depicts an illustrative architecture for an image and transaction reconciliation computer. FIG. 3 schematically depicts an illustrative data flow for image capture and processing for financial transaction in accordance with one or more embodiments of the disclosure. It should be appreciated that numerous other suitable configurations beyond the illustrative configurations depicted in FIGS. 1-3 are within the scope of this disclosure. The illustrative methods depicted in FIGS. 4-6 will be described through reference to the illustrative configurations shown in FIG. 1 and the illustrative image and transaction reconciliation computer depicted in FIG. 2.

The illustrative networked architecture 100 may include a client application system 104, one or more transaction systems 112, an image and transaction reconciliation system (ITRS) 118, and an image processing system 124 in communication over one or more networks 110.

The one or more systems may interact with each other across one or more networks 110, which may be local (e.g., when two systems are co-located at the same site) or wide area (e.g., when two systems are at different locations). In some embodiments, even within a particular system, a distributed architecture may call for system components to interact across one or more networks 110. The one or more networks 110 may be public (e.g., Internet, telephone) or private (e.g., frame relay), and may be based on any of a variety of protocols and connecting technologies. The one or more networks 110 may include, but not be limited to, a wireless fidelity (Wi-Fi) network, a Wi-Fi Direct network, an NFC connection, a radio network, a cellular network, the Internet, a GPS network, a ZigBee® connection, a Bluetooth® channel, a dial-up connection over a public telephone system, a private network (both wide area and local area), proprietary protocol connections, and other wireless links, as well as hardwired connections, serial link connections, parallel link connections, or combinations thereof.

In some embodiments, the client application system 104 may comprise one or more client application computers 106 and one or more client application datastores 108. The client application system 104 may be used by a user (e.g., a consumer or merchant) to capture an image of a document and submit it to the ITRS 118 for processing. The client application system 104 may reside entirely on one computing platform or on a plurality of computing platforms (e.g., a computing device of the user and one or more server computers). The user interface (UI) may be a “thick” client (e.g., a mobile app) or a “thin” client (e.g., a Web browser-based UI).

In some embodiments, the client application system 104 may transmit an image to the ITRS 118 on behalf of the user, and may not directly be used by the user (e.g., a server-based system at a remote location).

In some embodiments, one or more candidate transaction may be received by the client application system 104 and presented to a user for confirmation and/or selection. In some embodiments, the client application system 104 may present the one or more candidate transactions to a user and may receive a user response that may be submitted on behalf of the user to the ITRS 118.

The client application computers 106 may include a combination of application software and supporting operating system and 3rd-party tools (e.g., image capture functionality). These may be located on one computing platform or distributed.

The client application system datastore 108 may comprise application-specific and potentially user-specific data. The client application system datastores 108 may be located on one computing platform or may be distributed. Examples of data that may be stored in the client application datastore 108 may include, but is not limited to, client application system configuration parameters, client application system UI session information, client application system UI branding information, user profile information, user-specific non-transactional information (e.g., a payee list, in-application messages), and/or user-specific transactional information (e.g., pending transactions, recurring transaction models, recent transaction history).

The one or more transactions systems 112 may include one or more transaction computers 114 and one or more transaction datastores 116. In some embodiments, at least one transaction system 112 of record may contains a datastore 116 of transactions to be searched for one or more potential matches to a received document image. Examples of transaction systems 112 may include bank core account processing systems; online banking systems; bill payment systems; person-to-person payment systems; funds transfer systems; retail payment systems.

In some embodiments, a transaction that the user wants to associate an image with may already have been at least initiated (if not actually completed) and stored in a system of record. In some embodiments, the client application system 104 may overlap with the transaction system 112 of record (e.g., the transaction repository to be searched may be a server-based repository associated with the client application system.

In other implementations, the transaction system 112 of record may be independent of the client application system 104. In some embodiments, the transaction system 112 of record may be accessed by the client application system 104.

In some embodiments, a transaction may be in more than one system 112 of record (potentially in various forms). For example, a payment transaction may be in the payment history associated with a payment system, in a core account processing system when the transaction is posted to the financial account, and in an online banking system when posted transactions are extracted for presentation in an online banking UI.

The transaction system of record 112 comprises one or more transaction computers 114. A transaction computer 114 may include application functionality (e.g., Web services for performing certain application functions and/or accessing data) or underlying operating system or 3rd-party tools (e.g., a database management system) which may be located on one computing platform or distributed a distributed computing platform.

The transaction system of record datastore(s) 116 may contain the transactions to be searched for potential matches corresponding to the received document image. There may be just one datastore, multiple datastores associated with a single system, or one or more datastores associated with multiple systems. The one or more transaction datastores 116 may be located on one computing platform or a distributed computing platform.

The image and transaction reconciliation system (ITRS) 118 may contain one or more image and transaction reconciliation computers 120 and one or more datastore(s) 122. Although shown as distinct from the other systems, the ITRS 118 may be integrated with one or more of the other systems. The datastores 122 may store matching rules, processing parameters, etc. Other data, including the document images, may also be stored in the one or more datastores 122. In some embodiments, the association of an image with a transaction may be stored in the one or more datastores 122.

The image processing system 124 may comprise one or more computers 126 and one or more datastores 128 to support the processing and/or management of images. The image processing system 124 may provide functionality that may include the creation and/or maintenance of data extraction templates. In some embodiments, the image processing system 124 may provide image enhancement and/or normalization, image quality assessment, document type identification, data extraction, image identifier generation, and/or image storage and management.

The image processing datastore(s) 128 may comprise processing parameters and rules, data extraction templates, etc. In addition, the image processing system 124 may serve as the archival authority for images and the document images may be stored in the image processing system 124. In some embodiments, the extracted data or the data accompanying any image may be stored in the image processing system 124.

FIG. 2 depicts an illustrative architecture 200 of an image and transaction reconciliation computer 120 in accordance with one or more embodiments of the disclosure. The image and transaction reconciliation computer 120 may comprise one or more processors 202 and one or more memories 204 (generically referred to herein as memory 204). The processor(s) 202 may include any suitable processing unit capable of accepting digital data as input, processing the input data based on stored computer-executable instructions, generating output data, retrieving or storing data, and controlling the operation or use of various hardware resources through interfaces such as I/O interfaces 220 and network interfaces 222. The computer-executable instructions may be stored, for example, in the memory 204 and may include operating system software, application software, and so forth. The processor(s) 202 may be configured to execute the computer-executable instructions to cause various operations to be performed. The processor(s) 202 may include any type of processing unit including, but not limited to, a central processing unit, a microprocessor, a Reduced Instruction Set Computer (RISC) microprocessor, a microcontroller, an Application Specific Integrated Circuit (ASIC), and so forth.

The memory 204 may store program instructions that are loadable and executable by the processor(s) 202, as well as data manipulated and generated by the processor(s) 202 during execution of the program instructions. Depending on the configuration and implementation of the image and transaction reconciliation computer 120, the memory 204 may be volatile memory (memory that maintains its state when supplied with power) such as random access memory (RAM) and/or non-volatile memory (memory that maintains its state even when not supplied with power) such as read-only memory (ROM), flash memory, and so forth. In various implementations, the memory 204 may include multiple different types of memory, such as static random access memory (SRAM), dynamic random access memory (DRAM), unalterable ROM, and/or writeable variants of ROM such as electrically erasable programmable read-only memory (EEPROM), flash memory, and so forth.

The image and transaction reconciliation computer 120 may further include additional data storage 218 such as removable storage and/or non-removable storage including, but not limited to, magnetic storage, optical disk storage, and/or tape storage. Data storage 218 may provide non-volatile storage of computer-executable instructions and other data. The memory 204 and/or the data storage 218, removable and/or non-removable, are examples of computer-readable storage media (CRSM).

The image and transaction reconciliation computer 120 may additionally include one or more input/output (I/O) interfaces 220, such as a keyboard, a keypad, a mouse or other pointing device, a pen, a voice input device, a touch input device, a display, speakers, a camera, a microphone, a printer, and so forth, for receiving user input and/or providing output to a user.

The image and transaction reconciliation computer 120 may further include network interface(s) 222 that allow the image and transaction reconciliation computer 120 to communicate with other computing devices or application software forming part of the networked architecture 100 depicted in FIG. 1.

The memory 204 may include various program modules comprising computer-executable instructions that upon execution by the processor(s) 202 cause the image and transaction reconciliation computer 120 to perform various operations. For example, the memory 204 may have loaded therein an operating system (O/S) 206 that provides an interface between other application software executing on the image and transaction reconciliation computer 120 and hardware resources of the image and transaction reconciliation computer 120. More specifically, the O/S 206 may include a set of computer-executable instructions for managing hardware resources of the image and transaction reconciliation computer 120 and for providing common services to other application programs (e.g., managing memory allocation among various application programs). The O/S 206 may include any operating system now known or which may be developed in the future including, but not limited to, a Microsoft Windows® operating system, an Apple OSX™ operating system, Linux, Unix, a mainframe operating system such as Z/OS, a mobile operating system, or any other proprietary or freely available operating system.

The memory 204 may further include a database management system (DBMS) 208 for accessing, retrieving, storing, and/or manipulating data stored in one or more datastores. The DBMS 208 may use any of a variety of database models (e.g., relational model, object model, etc.) and may support any of a variety of query languages.

The memory 204 may further include various program modules comprising computer-executable instructions that upon execution by the processor(s) 202 cause the image and transaction reconciliation computer 120 to perform various operations. The functionality provided by these various program/application modules will be described in more detail hereinafter through reference to various accompanying drawings.

For example, the memory 204 may include a text field identification module 210, a candidate financial transaction identification module 212, and a confidence level generation module 214. Functionality supported by these various modules will be described in more detail through reference to the various illustrative methods depicted in the process flow diagrams of FIGS. 4-6.

The text field identification module 210 may provide functionality directed to communicating with an image processing system 124 and identifying one or more text fields associated with an image of a document.

The candidate financial transaction identification module 212 may provide functionality directed to communicating with one or more transaction systems 112 of record to identify one or more candidate financial transactions associated with or corresponding to an image.

The confidence level generation module 214 may provide functionality directed to determining and/or calculating a matching confidence level for an identified transaction candidate. The module 214 may determine and/or calculate the matching confidence level based at least in part on one or more factors, which may include the number of matching fields between an image and a transaction, how close within a tolerance range each field match is, and weighting associated with the individual field matches.

It should be appreciated that software, firmware, or hardware components depicted as forming part of the illustrative architecture 200, or more particularly, the image and transaction reconciliation computer 120, are merely illustrative and that some components may not be present or additional components may be provided in various embodiments. While various program modules have been depicted as being loaded in the memory 204, it should be appreciated that the functionality described as being supported by the program modules may be enabled by any combination of hardware, software, and/or firmware. It should further be appreciated that each of the above-mentioned modules depicted as being loaded into the memory 204 may, in various embodiments, represent a logical partitioning of functionality supported by the image and transaction reconciliation computer 120. This logical partitioning is depicted for ease of explanation of the functionality supported and may not be representative of the structure of software, firmware, and/or hardware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality.

### Illustrative Data Flow

FIG. 3 schematically depicts an illustrative data flow for image capture and processing for financial transactions. From a mobile platform 350, a customer may use a user device, such as a laptop, smartphone, tablet, or the like, at block 302, to login and navigate to a receipts function for viewing and capturing receipts. At block 304, a user may add a new receipt by taking a photo of the receipt. At block 306, the captured image may be pre-processed. At block 308, the pre-processed image may be transmitted to the ITRS 118 of the financial services platform 360. The ITRS 118 may transmit the received image to the image processing system 124 for processing. The image processing system 124 may, at block 310, process the image data and return identified text fields to the ITRS 118. At block 312, the ITRS 118 may communicate with an institution 370 with one or more transaction systems 112 of record to identify candidate financial transactions based at least in part on the identified text fields. Block 314 may be optional. At block 314, receipt images may be temporarily stored. At block 316, the ITRS 118 may transmit the list of candidate financial transactions to the mobile platform 350. At block 318, the user may tag or select one or more candidate financial transactions. At block 320, the ITRS 118 may store the receipt image in association with a tagged or selected financial transaction.

### Illustrative Process Flows

FIGS. 4-6 are process flow diagrams depicting alternative illustrative methods 400, 500, 600 for image capture and processing for financial transactions in accordance with one or more embodiments of the disclosure. The illustrative methods 400-600 will be described through reference to the illustrative networked architecture depicted in FIG. 1 and the illustrative configuration of an image and transaction reconciliation computer 200 as depicted in FIG. 2. However, it should be appreciated that the illustrative methods 400-600 may be performed in connection with any networked architecture and configuration within the scope of this disclosure. Further, while various operations are depicted in the process flow diagrams depicted in FIGS. 4-6, it should be appreciated that any of the depicted operations are optional and that, in various embodiments, any of the operations may not be performed. Further, in various embodiments, additional operations may be performed beyond those, which are depicted.

FIG. 4 is a process flow diagram depicting an illustrative method 400 for image capture and processing for financial transactions in accordance with one or more embodiments of the disclosure. In brief overview, at block 405, an image may be received. At block 410, text fields associated with the image may be identified. At block 415, candidate financial transactions may be identified. At block 420, candidate financial transactions may be transmitted for presentation to a user. At block 425, a selection of a candidate financial transaction may be received on behalf of a user. At block 430, an identifier of the image or the image itself may be stored in association with the selected candidate financial transaction or an identifier of the selected candidate financial transaction.

Still referring to FIG. 4, in more detail, at block 405, an image may be received. In some embodiments, the image may be an image received on behalf of a user from a client application system 104. For example, the client application system 104 may have captured an image of a receipt using a camera of a client application computer 106. In some embodiments, the image may require enhancement depending on how the image was captured. For example, if the image was captured using a flatbed scanner, then the quality of the image may be high and the image may not require any enhancement. In some embodiments, the image received by the ITRS 118 may already have been enhanced by another entity, such as the client application system 104. In some embodiments, if the image received by the ITRS 118 requires enhancement subsequent to receipt, the image may be enhanced by the image processing system 124.

In some embodiments, an identification of the type of document captured by the image may be received in association with the image. The type of document may be identified by a user of the client application system 104. For example, a user may select from a set of alternatives presented to her (or him). In another embodiment, the type of document may be detected automatically by the client application system 104. For example, the client application system 104 may analyze the image and determine the image is a receipt, an invoice, or the like. In some embodiment, the identification of the type of document may be used later to facilitate identification of relevant fields from the image.

In some embodiments, a geolocation associated with the image may be received. In some embodiments, the geolocation may be associated with or indicated in the image received by the ITRS 118. In some embodiments, the geolocation may correspond to a location the image was captured. In some embodiments, the geolocation may be used to associate the image to an identified financial transaction. For example, if a transaction has an address associated with it or with an attribute of the transaction, such as a payee, then by comparing a geolocation associated with the received image to the address, the ITRS 118 may be able to identify a possible association between the transaction and the image and transmit the transaction as a candidate financial transaction for presentation to the user.

At block 410, text fields associated with the received image may be identified. In some embodiments, identifying the text fields associated with the received image may involve transmitting the image to an image processing system 124 and receiving the text fields after the image has been processed. In some embodiments, identification of the type of document, if available, may also be transmitted to the image processing system 124, and may be used in the processing of the image. The processing performed by the image processing system 124 may include enhancing the image. The image processing system 124 may also perform a quality assessment of the image. For example, the image processing system 124 may determine whether the image is of sufficient quality for optical character recognition (OCR) processing. The image processing system 124 may perform OCR processing on the image.

In some embodiments, the image processing system 124 may identify text fields based at least in part on the OCR processing. The image processing system 124 may identify text fields that have particular characteristics, which may be based, at least in part, on an identified or received document type associated with the image. For example, for a purchase receipt, the name of a retailer may be identified as a text string at the top or bottom of the receipt image. A total purchase amount may be identified as a figure with two decimal places at the bottom of a list of figures, or in the horizontal vicinity of the word “Total”. A purchase date may be identified as a text string conforming to any of a variety of commonly used date formats. Certain camera devices may capture a geolocation or date of the image capture in the image, which could also be helpful in identification of associated transactions.

In some embodiments, the image processing system 124 may perform a template-based data extraction based at least in part on an identification of a type of document of the image. In some embodiments, the image processing system 124 may perform a template-based data extraction based at least in part an identification of an entity associated with generating the document captured in the image. For example, if the type of document were identified as “an insurance explanation of benefits”, an insurance provider may be identified (e.g., by analyzing specific regions of the image). Then, the identification of the insurance provider may be used to identify a template for processing explanations of benefits from that insurance company. Fields like the health service provider, the date of service, and the amount due to the health service provider may be extracted from particular locations as identified by the template.

In some embodiments, the image processing system 124 may generate an identifier for the image. The document image may be stored in a data repository or datastore in association with the generated identifier. The image processing system 124 may then transmit the identified text fields, optionally with the generated identifier, to the ITRS 118.

At block 415, candidate financial transactions may be identified. In some embodiments, the ITRS 118 may communicate with one or more transaction systems 112 of record to search financial transactions using values based at least in part on the identified text fields from the image. In some embodiments, the ITRS 118 may query the one or more transaction systems 112 using any combination of attributes, identified text fields, alternative forms of identified text fields, values derived from one or more identified text fields, or supplemental information associated with the image, such as a geolocation associated with the image. For example, if the text fields were identified from a purchase receipt, a search may be performed for any debit/payment transaction with i) a payee corresponding to the identified retailer name, ii) a date corresponding to the purchase date, and iii) an amount corresponding to the purchase amount. Supplemental information, such as a geolocation received in association with the image or extracted from the image, may be submitted to match to a geolocation or an address associated with a transaction. A date of image capture (e.g., which may have been imprinted into the image and identified by the image processing system 124) may be used in lieu of a purchase date extracted from the receipt.

In another example, if the text fields associated with an image were identified from an insurance explanation of benefits, a search may be performed for any debit/payment transaction with i) a payee corresponding to the identified health service provider, ii) a date subsequent to the identified date of service, and iii) an amount corresponding to the identified amount due to the health service provider.

In some embodiments, the ITRS 118 may determine that text fields identified by the image processing system 124 fall within a particular allowable tolerance, which may be rule-based according to document type and/or field. For example, the payee designation in online banking may not be exactly the same as the retailer name on a receipt. There may be an algorithmic normalization process. Likewise, the transaction date in online banking may not be the same as the date on the receipt. Therefore, different amounts of deviation may be allowed for those two document types. While the transaction and purchase amounts may be precisely the same in a purchase receipt context, the transaction amount and amount due to a health service provider could differ in an insurance explanation of benefits context (e.g., when a user might make partial payments over an extended period of time). The preceding example may be indicative of a situation in which one transaction system of record could yield multiple candidate financial transactions corresponding to one image (e.g., the series of payments).

In some embodiments, the ITRS 118 may determine whether to consider transactions that match on less than all of the fields. For example, a transaction that matches on date and amount may be considered even though the payee name may not match.

In some embodiments, the ITRS 118 may receive a set of candidate transactions from each available transaction system 112 of record. The ITRS 118 may compile or aggregate the candidate transactions from each available transaction system 112 of record into a single set of candidate transactions. Each candidate transaction may identify transaction details (e.g., date, party, amount, etc.). The ITRS 118 may optionally also identify one or more transaction systems 112 of record and/or a financial account associated with the transactions.

At block 420, candidate financial transactions may be transmitted for presentation to a user. In some embodiments, the identified candidate financial transactions may be ordered by one or more attributes (e.g., date, amount, geolocation, etc.). The identified candidate financial transactions may be transmitted to the client application system 104 for presentation to the user. Additionally, data associated with the identified candidate financial transaction may also be transmitted to the client application system 104. The user may be provided with an opportunity to verify applicability of the identified candidate financial transaction, indicate incorrect associations of information that should be removed, and indicate which (if any) of the candidate financial transactions should be associated with the image. In some embodiments, a user may be allowed to associate more than one candidate financial transaction with an image.

At block 425, a selection of one or more candidate financial transactions (referred to hereafter in the singular for simplicity) may be received on behalf of a user. A user selection of a candidate financial transaction that should be associated with the document image may be received by the ITRS 118. This may be in addition to or in lieu of any automated associations of data with the image. In some embodiments, a user selection of a candidate financial transaction may include the client application system 104 receiving an indication identifying one of the presented candidate financial transactions. For example, if the user is presented with a list of the candidate financial transactions on a touchscreen and the user taps on a region associated with one of the candidates, the client application system 104 may capture the tap as an indication of the user's selection of the particular candidate.

At block 430, an identifier of the image may be stored in association with the selected candidate financial transaction. In some embodiments, the image or the image identifier may be stored in association with the user-selected candidate financial transaction or an identifier associated with this transaction. Other prior automated associations may be removed, as the user has also individually indicated or as called for by the system implementation. In some embodiments, the association of the image and the selected candidate financial transaction may be stored in a transaction system of record.

FIG. 5 is a process flow diagram depicting another illustrative method 500 for image capture and processing for candidate financial transactions in accordance with one or more embodiments of the disclosure. In brief overview, at block 505, an image may be received. At block 510, text fields associated with the image may be identified. At block 515, candidate financial transactions may be identified. At block 520, a best-fit candidate financial transaction may be identified. At block 525, an identifier of the image or the image itself may be stored in association with the best-fit candidate financial transaction or an identifier of the best-fit candidate financial transaction. At block 530, candidate financial transactions may be transmitted for presentation to a user. At block 535, a selection of a candidate financial transaction may be received on behalf of a user. At block 540, an identifier of the image (or the image itself) may be stored in association with the selected candidate financial transaction.

Still referring to FIG. 5, and in more detail, at block 505, an image may be received. The image may be an image captured by the client application system 104 or another entity in association with a user device. In some embodiments, the ITRS 118 may receive an image from a client application system 104. Block 505 may include similar details as those described in association with block 405 of FIG. 4.

At block 510, text fields associated with the image may be identified. In some embodiments, the ITRS 118 may transmit the image to the image processing system 124 for processing. The processing may include optical character recognition or template-based data extraction. The image processing system 124 may enhance the image, if necessary, and process to the image to identify one or more text fields associated with the image. The image processing system 124 may communicate the identified text fields and optionally an image identifier to the ITRS 118. Block 510 may include similar details as those described in association with block 410 of FIG. 4.

At block 515, candidate financial transactions may be identified. In some embodiments, the ITRS 118 may communicate with one or more transaction systems 112 of record to search transactions and identify one or more candidate financial transactions. In some embodiments, the query may use any combination of attributes, identified text fields, alternative forms of identified text fields, values derived from identified text fields, or supplemental information associated with the image, and other information. Supplemental information associated with the image may include geolocation or other such data. Additionally, block 515 may include similar details as those describe in association with block 415 in FIG. 4.

At block 520, a best-fit candidate financial transaction may be identified. In some embodiments, the ITRS 118 may identify a best-fit candidate financial transaction from the set of identified candidate financial transactions. In some embodiments, the ITRS 118 may determine or calculate a matching confidence level associated with each of the identified candidate financial transactions. Determining a matching confidence level for each of the candidate financial transactions may be based at least in part on any number of a variety of factors, which may include but are not limited to the number of matched fields between the image and candidate financial transaction, the tolerance range associated with each matched text field, and different weighting associated with the matching of different fields. The ITRS 118 may then order the set of candidate financial transactions based on their respective matching confidence levels. In some embodiments the candidate financial transaction with the matching confidence level denoting the highest confidence level (which may be a numerically high or low value) in the set of identified candidate financial transactions may then be determined to be the best-fit candidate financial transaction. If there are multiple candidate financial transactions with the same matching confidence level, all the candidate financial transactions with the highest matching confidence levels may be identified as the best-fit candidates. Alternatively, one of the multiple candidates may be selected based at least in part on a rule or preference of the ITRS 118. For example, preference may be given to certain transaction systems 112 of record or financial accounts.

In some embodiments, identifying best-fit candidate financial transaction may include receiving optical character recognition (OCR) output and extracting key value(s), which may include a total amount and transaction date from the image. In some embodiments, extraction may be done based at least in part on recognizing common patterns in the image. Further, in some embodiments, a matching algorithm may be run based at least in part on the key value(s) extracted. In some embodiments, if not results are identified by the matching algorithm, a fuzzy match algorithm may be run, which may extend the search range.

At block 525, an identifier of the image or the image itself may be stored in association with the best-fit candidate financial transaction. In some embodiments, the identifier of the image may be generated by the ITRS 118. In some embodiments, the identifier may be generated by the image processing system 124. The image or the image identifier may be stored in association with the identified best-fit candidate financial transaction or an identifier for the candidate financial transaction. In some embodiments, the association may be stored in a repository associated with the ITRS 118, one or more transaction systems 112, image processing systems 124, and/or client application systems 104. In the case of multiple best-fit candidate financial transactions, the image identifier or image may be stored in association with each of the best-fit candidate financial transactions or a respective identifier for each of the best-fit candidate financial transactions. In some embodiments, the method 500 for capturing and processing images for financial transactions may terminate or end at this block. In other embodiments, the method 500 may continue to block 530.

At block 530, candidate financial transactions may be transmitted for presentation to a user. In some embodiments, all of the candidate financial transactions may be transmitted, with an indication of the candidate financial transaction that is the identified best-fit candidate financial transaction. In some embodiments, only the best-fit candidate financial transaction is transmitted for presentation to a user. In some embodiments, a subset of the identified candidate financial transactions may be transmitted, wherein the subset includes candidate financial transactions with a matching confidence levels that meet a pre-determined threshold. In some embodiments, a pre-determined number of candidate transaction transactions may be transmitted for presentation to the user.

At block 535, a selection of one or more candidate financial transactions may be received on behalf of a user. In some embodiments, a client application system 104 may present the identified candidate financial transactions to a user via a user device. The user device may receive an indication from the user of a selection of the one or more candidate financial transactions and communicate the selection to the ITRS 118.

At block 540, an identifier of the image or the image itself may be stored in association with the selected one or more candidate financial transactions or respective identifiers of the selected one or more candidate financial transactions. In some embodiments, the ITRS 118 may associate the image identifier with the selected candidate financial transaction. The ITRS 118 may store the association in one or more data repositories in the system 100. In some embodiments, the image or the image identifier may be stored in association with the user-selected candidate financial transaction or an identifier associated with this transaction. Other prior automated associations may be removed, as the user has also individually indicated or as called for by the system implementation.

FIG. 6 is a process flow diagram depicting another illustrative method 600 for image capture and processing for financial transactions in accordance with one or more embodiments of the disclosure. In brief overview, at block 605, an image may be received. At block 610, text fields associated with the image may be identified. At block 615, candidate financial transactions may be identified. At block 620, a best-fit candidate financial transaction may be identified. At block 625, an identifier of the image or the image itself may be stored in association with the best-fit candidate financial transaction or an identifier of the best-fit candidate financial transaction. At block 630, the best-fit candidate financial transaction may be transmitted for presentation to the user in association with the image.

Still referring to FIG. 6, and in more detail, at block 605, an image may be received. The image may be an image captured by the client application system 104 or another entity in association with a user device. In some embodiments, the ITRS 118 may receive an image from a client application system 104. Block 605 may include similar details as those described in association with block 405 of FIG. 4.

At block 610, text fields associated with the image may be identified. At block 615, candidate financial transactions may be identified. In some embodiments, the ITRS 118 may transmit the image to the image processing system 124 for processing. The processing may include optical character recognition or template-based data extraction. The image processing system 124 may enhance the image, if necessary, and process to the image to identify one or more text fields associated with the image. The image processing system 124 may communicate the identified text fields and optionally a generated image identifier to the ITRS 118. Block 610 may include similar details as those described in association with block 410 of FIG. 4.

At block 615, candidate financial transactions may be identified. In some embodiments, the ITRS 118 may communicate with one or more transaction systems 112 of record to search transactions and identify one or more candidate financial transactions. In some embodiments, the query may use any combination of attributes, identified text fields, alternative forms of identified text fields, values derived from identified text fields, supplemental information associated with the image, and other information. Supplemental information associated with the image may include geolocation or other such data. Additionally, block 615 may include similar details as those describe in association with block 415 in FIG. 4.

At block 620, a best-fit candidate financial transaction may be identified. In some embodiments, the ITRS 118 may identify a best-fit candidate financial transaction from the set of identified candidate financial transactions. In some embodiments, the ITRS 118 may the ITRS 118 may determine or calculate a matching confidence level associated with each of the identified candidate financial transactions, as described in association with block 520 of FIG. 5. The ITRS 118 may order the set of candidate financial transactions based on their respective matching confidence levels. In some embodiments the candidate transaction with the matching confidence level denoting the highest confidence level (which may be a numerically high or low value) in the set of identified candidates may then be determined to be the best-fit candidate transaction. If there are multiple candidate transactions with the same matching confidence level, all the candidate transactions with the highest matching confidence levels may be identified as the best-fit candidates. Alternatively, one of the multiple candidates may be selected based at least in part on a rule or preference of the ITRS 118. For example, preference may be given to certain transaction systems 112 of record or financial accounts.

At block 625, an identifier of the image or the image itself may be stored in association with the best-fit candidate financial transaction(s) or respective identifier(s) of the best-fit candidate financial transaction(s). In some embodiments, the identifier of the image may be generated by the ITRS 118. In some embodiments, the identifier may be generated by the image processing system 124. The image or the image identifier may be stored in association with the identified best-fit candidate transaction or an identifier for the transaction. In some embodiments, the identifier may be stored in a repository associated with the ITRS 118, one or more transaction systems 112, image processing systems 124, and/or client application systems 104. In the case of multiple best-fit candidates, the image identifier may be stored in association with each of the best-fit candidates.

At block 630, the best-fit candidate financial transaction may be transmitted for presentation to the user. The transmission may optionally include the associated image or an identifier of the associated image. In some embodiments, block 630 may be optional. The ITRS 118 may be transmitted over one or more networks 110 to a client application system 104 for presentment to a user.

### Illustrative Interfaces

### View Transaction History

FIGS. 7A-7C depict various user interfaces for a user to view a transaction history. FIG. 7A depicts an interface 700 listing one or more accounts associated with a user. The interface depicts a checking account 704 and a credit card account 706. By selecting the checking account 704, the user may advance to the interface depicted in FIG. 7B.

FIG. 7B depicts an interface 730 displaying or presenting to a user a transaction history associated with the checking account 704. The transaction history may list multiple transactions associated with the checking account 704. Some transactions may display a receipt icon 734, while other transactions do not display 736 an icon. The receipt icon 734 may indicate that a transaction has been tagged with a receipt. If a user selects a transaction that displays a receipt icon 734, the user may be advanced to the interface depicted in FIG. 7C. If a user selects a transaction that has not been tagged, further details associated with the transaction may be presented to the user. The user may be presented with an option to capture an image. If the user selects the option to capture an image, then the user may capture an image of a document via the user device, such as a receipt, or select an image of a document to tag with the transaction.

FIG. 7C may depict an interface 760 presenting the user with the image associated with the transaction, as well as any supplemental information that may have been stored in association with the image. The interface may display the image 762, a comment 764 or note associated with the image, a map 764 if the image is associated with geolocation information, and transaction details 768 that may have been obtained from text fields associated with the image or supplemental information stored in association with the image.

While various illustrative presentations of the information and types of content have been described in connection with FIGS. 7A-7C, it should be appreciated that numerous other variations, modifications, and so forth are within the scope of this disclosure. Further, although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, although specific example embodiments have been presented, it should be appreciated that numerous other examples are within the scope of this disclosure.

Additional types of CRSM that may be present in association with any of the components described herein (e.g., any of the components of the networked architecture 100) may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, solid-state memory devices, or any other medium. Combinations of any of the above are also included within the scope of CRSM.

Alternatively, computer-readable communication media may include computer-readable instructions, program modules, or other data transmitted within a data signal, such as a carrier wave, or other transmission. However, as used herein, CRSM does not include computer-readable communication media. Examples of computer-readable communication media, whether modulated using a carrier or not, include, but are not limited to, signals that a computer system or machine hosting or running a computer program can be configured to access, including signals downloaded through the Internet or other networks. For example, the distribution of software may be an Internet download.

Although embodiments have been described in language specific to structural features and/or methodological acts, it is to be understood that the disclosure is not necessarily limited to the specific features or acts described. Rather, the specific features and acts are disclosed as illustrative forms of embodiments of the disclosure. Conditional language such as, for example, “can,” “could,” “might,” or “may,” unless specifically stated otherwise, or unless otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

That which is claimed is:

1. A computer-implemented method, comprising:
receiving, by a financial system comprising one or more computers on behalf of a user, an image of a document;
identifying, by the financial system, one or more text fields associated with the image;
identifying, by the financial system based at least in part on the identified one or more text fields, one or more candidate financial transactions;
transmitting, by the financial system for presentment to the user, the one or more candidate financial transactions;
receiving, by the financial system from the user, a selection of one of the one or more candidate financial transactions; and
associating, by the financial system, the image with the selected one of the one or more candidate financial transactions.

2. The computer-implemented method of claim 1, further comprising:
receiving, by the financial system, geolocation data associated with the image.

3. The computer-implemented method of claim 1, further comprising:
receiving, by the financial system, a document type identifier associated with the image.

4. The computer-implemented method of claim 1, wherein identifying the one or more text fields associated with the image further comprises:
transmitting, by the financial system to an image processing system, the image of the document; and
receiving, by the financial system from the image processing system, the one or more text fields associated with the image.

5. The computer-implemented method of claim 4, further comprising:
receiving, by the financial system, an image identifier associated with the image.

6. The computer-implemented method of claim 1, wherein identifying the one or more candidate financial transactions comprises:
identifying, by the financial system, the one or more candidate financial transactions based at least in part on geolocation data associated with the image or a date of image capture associated with the image.

7. The computer-implemented method of claim 1, further comprising:
receiving, by the financial system, the one or more candidate financial transactions from one or more transaction systems of record.

8. The computer-implemented method of claim 1, wherein each of the one or more candidate financial transactions comprise:
a respective at least one transaction field corresponding to one of the one or more text fields associated with the image.

9. The computer-implemented method of claim 8, wherein a correspondence of the at least one transaction field to one of the one or more text fields is within a predetermined tolerance threshold.

10. The computer-implemented method of claim 8, further comprising:
transforming, by the financial system, at least one of the at least one transaction field or one of the one or more text fields; and
determining, by the financial system, a correspondence of the at least one transaction field to one of the one or more text fields.

11. A system, comprising:
one or more computers comprising:
at least one memory storing computer-executable instructions; and
at least one processor configured to access the at least one memory and to execute the computer-executable instructions to:
receive an image of a document on behalf of a user;
identify one or more text fields associated with the image;
identify one or more candidate financial transactions based at least in part on the identified one or more text fields;
transmit the one or more candidate financial transactions for presentment to the user;
receive a selection of one of the one or more candidate financial transactions from the user; and
associate the image with the selection of the one of the one or more candidate financial transactions from the user.

12. The system of claim 11, wherein the at least one processor is configured to:
receive geolocation data associated with the image.

13. The system of claim 11, wherein the at least one processor is configured to:
receive an image identifier associated with the image.

14. The system of claim 11, wherein the at least one processor is configured to:
transmit the image of the document to an image processing system; and
receive, from the image processing system, the one or more text fields associated with the image.

15. The system of claim 15, wherein the at least one processor is configured to:
receive an image identifier associated with the image.

16. The system of claim 11, wherein the at least one processor is configured to:
identify the one or more candidate financial transactions based at least in part on geolocation data associated with the image or a date of image capture associated with the image.

17. The system of claim 11, wherein the at least one processor is configured to:
receive the one or more candidate financial transactions from one or more transaction systems of record.

18. The system of claim 11, wherein the at least one processor is configured to:
sort the one or more candidate financial transactions.

19. The system of claim 11, wherein the at least one processor is configured to:
receive a second selection of the one or more candidate financial transactions from the user; and
associate the image with the second selection of the one or more candidate financial transactions from the user.

20. The system of claim 11, wherein the association of the image with the selection of the one of the one or more candidate financial transactions from the user further comprises at least one of:
i) storage of at least one of the image or an identifier associated with the image in association with the selection of the one of the one or more candidate financial transactions or an identifier associated with the selection of the one or more candidate financial transaction;
ii) transmission of at least one of the image or the identifier associated with the image for storage in association with the selection of the one of the one or more candidate financial transactions or the identifier associated with the selection of the one or more candidate financial transactions; or
iii) transmission of at least one of the selection of the one or more candidate financial transactions or identifier associated with the selection of the one of the one or more candidate financial transactions for storage in association with the image or the identifier associated with the image.

21. The system of claim 11, wherein the at least one processor is configured to:
determine a respective confidence level associated with each of the one or more candidate financial transactions;
identify a best-fit candidate transaction, wherein the best-fit candidate transaction is a candidate financial transaction of the one or more candidate financial transactions associated with a highest confidence level.

22. The system of claim 21, wherein the at least one processor is further configured to:
associate the image with the best-fit candidate transaction; and
transmit an indication of the association for presentation to the user.

23. The system of claim 22, wherein the at least one processor is further configured to:
receive an indication on behalf of the user to remove the association of the image with the best-fit candidate transaction; and
remove the association of the image with the best-fit candidate transaction.

24. A computer-implemented method, comprising:
receiving, by a financial system comprising one or more computer, an image of a document on behalf of a user;
identifying, by the financial system, one or more text fields associated with the image;
identifying, by the financial system, one or more candidate financial transactions based at least in part on the identified one or more text fields;
determining, by the financial system, a best-fit candidate transaction from the one or more candidate financial transactions; and
associating, by the financial system, the image with the best-fit candidate financial transaction.
